(19) United States
(12) Patent Application Publication
(10) Pub. No.: US 2026/0106135 A1
(43) Pub. Date: Apr. 16, 2026

(54) Li, Mn-RICH CATHODE FOR HIGH-ENERGY AND HIGH-RETENTION Li-ION BATTERY

(71) Applicant: SAMSUNG SDI CO., LTD., Yongin-si (KR)

(72) Inventors: Zijian CAI, Cambridge, MA (US); Qingjie LI, Cambridge, MA (US); Yan WANG, Cambridge, MA (US); Michael CHON, Cambridge, MA (US); Valentina LACIVITA, Cambridge, MA (US)

(21) Appl. No.: 19/360,826

(22) Filed: Oct. 16, 2025

Related U.S. Application Data
(63) Continuation-in-part of application No. 19/086,526, filed on Mar. 21, 2025.
(60) Provisional application No. 63/708,143, filed on Oct. 16, 2024.

(30) Foreign Application Priority Data
Jul. 16, 2025 (KR) 10-2025-0096373
Aug. 28, 2025 (KR) 10-2025-0121521

(51) Int. Cl. H01M 4/1391; H01M 4/02; H01M 10/0525

(52) U.S. Cl. CPC H01M 4/1391; H01M 10/0525; H01M 2004/028

(57) ABSTRACT

A compound for use in a lithium, manganese-rich cathode for a Li-ion battery is Li_{1.2}Ni_{0.2}Mn_{0.6}O₂ triple doped with Na⁺, Co³⁺, and Mg²⁺. A lithium, manganese-rich cathode for an Li-ion battery includes the aforementioned compound. A lithium-ion battery includes an anode, a cathode, and an electrolyte, wherein the cathode is the aforementioned lithium, manganese-rich cathode.

### CROSS-REFERENCE TO RELATED APPLICATION

This application is a continuation-in-part of U.S. patent application Ser. No. 19/086,526, filed on Mar. 21, 2025, which claims priority to and the benefit of U.S. Provisional Application No. 63/708,143, filed on Oct. 16, 2024. This application also claims priority to and the benefit of Korean Patent Application No. 10-2025-0096373 filed on Jul. 16, 2025, in the Korean Intellectual Property Office, and Korean Patent Application No. 10-2025-0121521 filed on Aug. 28, 2025, in the Korean Intellectual Property Office. The disclosures of all of which are incorporated herein by reference in their entirety.

### BACKGROUND

### 1. Field

Embodiments of the present disclosure relate to compounds for use in cathodes for Li-ion batteries, as well as to cathodes including those compounds and to Li-ion batteries including those cathodes.

### 2. Description of the Related Art

A high capacity cathode is a key to the realization of high-energy-density lithium-ion batteries.

Due to their high specific capacities beyond 250 mAh g⁻¹, lithium-rich oxides have been considered as promising cathodes for the next generation power batteries, bridging the capacity gap between traditional layered-oxide based lithium-ion batteries and future lithium metal batteries such as lithium sulfur and lithium air batteries.

However, the practical application of Li-rich oxides has been hindered by undesirable capacity and voltage retention caused by irreversible oxygen redox.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

To satisfy the above need, the present disclosure provides materials for use in lithium, manganese-rich (LMR) cathodes for Li-ion batteries, according to embodiments.

In particular, the present disclosure provides doped compounds for use in LMR cathodes for Li-ion batteries.

A first embodiment of the present disclosure provides lithium nickel manganese-based oxide comprising Li_{1.2}Ni_{0.2}Mn_{0.6}O₂ triple doped with Na⁺, Co³⁺, and Mg²⁺. In some example embodiments, the lithium nickel manganese-based oxide comprises sodium (Na), cobalt (Co), and magnesium (Mg) and is represented by Formula 1,

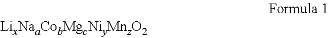

wherein, in Formula 1, 0.9≤x<1.2, 0<a≤0.0375, 0<b≤0.0375, 0<c≤0.0375, 0.1≤y<0.3, 0.3≤z<0.7.

A second embodiment of the present disclosure provides lithium nickel manganese-based oxide of the first embodiment, which is Li_{1.15}Na_{0.0375}Co_{0.025}Mg_{0.0125}Ni_{0.19375}Mn_{0.58125}O₂.

A third embodiment of the present disclosure provides lithium nickel manganese-based oxide of the first embodiment, which is Li_{1.1425}Na_{0.0375}Co_{0.025}Mg_{0.025}Ni_{0.1925}Mn_{0.5775}O₂.

A fourth embodiment of the present disclosure provides lithium nickel manganese-based oxide of the first embodiment, which is Li_{1.135}Na_{0.0375}Co_{0.025}Mg_{0.0375}Ni_{0.19125}Mn_{0.57375}O₂.

A fifth embodiment of the present disclosure provides lithium nickel manganese-based oxide of the first embodiment, which is Li_{1.1475}Na_{0.0375}Co_{0.0375}Mg_{0.0125}Ni_{0.19125}Mn_{0.57375}O₂.

A sixth embodiment of the present disclosure provides lithium nickel manganese-based oxide of the first embodiment, which is Li_{1.14}Na_{0.0375}Co_{0.0375}Mg_{0.025}Ni_{0.19}Mn_{0.57}O₂.

A seventh embodiment of the present disclosure provides lithium nickel manganese-based oxide of the first embodiment, which is Li_{1.1325}Na_{0.0375}Co_{0.0375}Mg_{0.0375}Ni_{0.18875}Mn_{0.56625}O₂.

An eighth embodiment of the present disclosure provides a lithium, manganese-rich cathode comprising Li_{1.2}Ni_{0.2}Mn_{0.6}O₂ triple doped with Na⁺, Co³⁺, and Mg²⁺. In some example embodiments, the lithium, manganese-rich cathode comprises lithium nickel manganese-based oxide, and the lithium nickel manganese-based oxide comprises sodium (Na), cobalt (Co), and magnesium (Mg) and is represented by Formula 1,

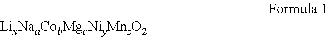

wherein, in Formula 1, 0.9≤x<1.2, 0<a≤0.0375, 0<b≤0.0375, 0<c≤0.0375, 0.1≤y<0.3, 0.3≤z<0.7.

A ninth embodiment of the present disclosure provides a lithium, manganese-rich cathode of the eighth embodiment, comprising Li_{1.15}Na_{0.0375}Co_{0.025}Mg_{0.0125}Ni_{0.19375}Mn_{0.58125}O₂.

A tenth embodiment of the present disclosure provides a lithium, manganese-rich cathode of the eighth embodiment, comprising Li_{1.1425}Na_{0.0375}Co_{0.025}Mg_{0.025}Ni_{0.1925}Mn_{0.5775}O₂.

An eleventh embodiment of the present disclosure provides a lithium, manganese-rich cathode of the eighth embodiment, comprising Li_{1.135}Na_{0.0375}Co_{0.025}Mg_{0.0375}Ni_{0.19125}Mn_{0.57375}O₂.

A twelfth embodiment of the present disclosure provides a lithium, manganese-rich cathode of the eighth embodiment, comprising Li_{1.1475}Na_{0.0375}Co_{0.0375}Mg_{0.0125}Ni_{0.19125}Mn_{0.57375}O₂.

A thirteenth embodiment of the present disclosure provides a lithium, manganese-rich cathode of the eighth embodiment, comprising Li_{1.14}Na_{0.0375}Co_{0.0375}Mg_{0.025}Ni_{0.19}Mn_{0.57}O₂.

A fourteenth embodiment of the present disclosure provides a lithium, manganese-rich cathode of the eighth embodiment, comprising Li_{1.1325}Na_{0.0375}Co_{0.0375}Mg_{0.0375}Ni_{0.18875}Mn_{0.56625}O₂.

A fifteenth embodiment of the present disclosure provides a lithium-ion battery comprising an anode, a cathode, and an electrolyte, wherein the cathode is a lithium, manganese-rich cathode comprising Li_{1.2}Ni_{0.2}Mn_{0.6}O₂ triple doped with Na⁺, Co³⁺, and Mg²⁺. In some example embodiments, the cathode comprises lithium nickel manganese-based oxide comprising sodium (Na), cobalt (Co), and magnesium (Mg) and represented by Formula 1,

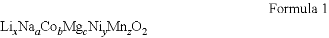

wherein, in Formula 1, 0.9≤x<1.2, 0<a≤0.0375, 0<b≤0.0375, 0<c≤0.0375, 0.1≤y<0.3, 0.3≤z<0.7.

A sixteenth embodiment of the present disclosure provides a lithium-ion battery of the fifteenth embodiment, wherein the cathode is a lithium, manganese-rich cathode comprising Li_{1.15}Na_{0.0375}Co_{0.025}Mg_{0.0125}Ni_{0.19375}Mn_{0.58125}O₂.

A seventeenth embodiment of the present disclosure provides a lithium-ion battery of the fifteenth embodiment, wherein the cathode is a lithium, manganese-rich cathode comprising Li_{1.1425}Na_{0.0375}Co_{0.025}Mg_{0.025}Ni_{0.1925}Mn_{0.5775}O₂.

An eighteenth embodiment of the present disclosure provides a lithium-ion battery of the fifteenth embodiment, wherein the cathode is a lithium, manganese-rich cathode comprising Li_{1.135}Na_{0.0375}Co_{0.025}Mg_{0.0375}Ni_{0.19125}Mn_{0.57375}O₂.

A nineteenth embodiment of the present disclosure provides a lithium-ion battery of the fifteenth embodiment, wherein the cathode is a lithium, manganese-rich cathode comprising Li_{1.1475}Na_{0.0375}Co_{0.0375}Mg_{0.0125}Ni_{0.19125}Mn_{0.57375}O₂.

A twentieth embodiment of the present disclosure provides a lithium-ion battery of the fifteenth embodiment, wherein the cathode is a lithium, manganese-rich cathode comprising Li_{1.14}Na_{0.0375}Co_{0.0375}Mg_{0.025}Ni_{0.19}Mn_{0.57}O₂ or Li_{1.1325}Na_{0.0375}Co_{0.0375}Mg_{0.0375}Ni_{0.18875}Mn_{0.56625}O₂.

### BRIEF DESCRIPTION OF DRAWINGS

Example embodiments of the present disclosure will be more clearly understood from the following detailed description taken in conjunction with the accompanying drawing in which:

FIG. 1 shows an X-ray diffraction pattern for synthesized Na/Co/Mg doped Li_{1.2}Ni_{0.2}Mn_{0.6}O₂(LNMO1226) embodiments of the present disclosure.

FIG. 2 shows a graph of specific capacity vs. cycle number and a corresponding table including an embodiment of the present disclosure.

FIG. 3 is a graph showing the specific capacity for a Na/Co/Mg doped embodiment of the present disclosure compared with embodiments doped with other dopants.

### DETAILED DESCRIPTION OF EXAMPLE EMBODIMENTS

As mentioned above, the present disclosure provides doped compounds for use in LMR cathodes for Li-ion batteries.

The major concern for lithium, manganese-rich (LMR) cathodes is the low capacity retention when charging to high voltages (>4.7V). To facilitate the industry application of LMR, the LMR cathode is only charged to high voltage in the formation cycle and cycles within a narrow voltage window (2-4.5V or 2.5-4.45V) in the following cycles. Although the retention can be improved, the capacity and energy density are compromised. The present disclosure addresses this issue experimentally by high-throughput screening suitable dopants for improving capacity within a narrow cycling window. It was found that Na⁺, Co³⁺ and Mg²⁺ triple doping can dramatically increase the capacity, as well as cycling retention. This new finding is significantly different than the single dopant strategy reported in the literature as the strategy of the present disclosure uses triple dopants. The combination of Na⁺, Co³⁺ and Mg²⁺ further improves the electrochemical performance compared with a single dopant.

Thus, Na⁺, Co³⁺ and Mg²⁺ triple dopants are applied in LMR Li_{1.2}Ni_{0.2}Mn_{0.6}O₂. The initial capacity and retention are improved with this strategy. In particular, the initial capacity and retention are improved by Na⁺, Co³⁺ and Mg²⁺ triple dopants in Li_{1.2}Ni_{0.2}Mn_{0.6}O₂.

The lithium-containing oxide in this disclosure can be made by a solid-state method and doped by a doping method in the art, except that the doping is with three dopants rather than a single dopant. A cathode can then be formed from by a cathode manufacturing method in the art, except that the material used to form the cathode is the triple doped lithium-containing oxide of the present disclosure rather than another material.

The cathode can then be used in a lithium-ion battery comprising an anode, a cathode, and an electrolyte, particularly a high-energy Li-ion battery. The battery can be formed by a battery manufacturing method in the art, except that the cathode used to form the battery is a cathode of the present disclosure, which contains the triple doped lithium-containing oxide of the present disclosure rather than another material.

Specific embodiments of the present disclosure were synthesized and tested according to the following synthesis and test protocol for doped Li_{1.2}Ni_{0.2}Mn_{0.6}O₂(LNMO1226).

In a total of 500 mg Ni_{0.25}Mn_{0.75}(OH)₂, Li₂CO₃ (5% excess to compensate the Li loss at high temperature) and Na₂CO₃, Co₃O₄, MgO and/or MgCO₃ were dosed into crucibles and mixed as appropriate for Na doped, Co doped, NaCo doped, and NaCoMg doped embodiments.

To synthesize LNMO1266, the temperature was ramped to 600° C. within 2 h and held at 600° C. for 1 h before ramping to the final sinter temperature (950° C.) and holding for 12 h.

The product was ground by hand in mortar and pestle to reduce the agglomeration.

350 mg of product was mixed with 100 mg carbon and 1 g 5% PVDF/NMP by a Thinky mixer.

The slurry was cast on Al foil and dried overnight before calendering and punching to make coin cells.

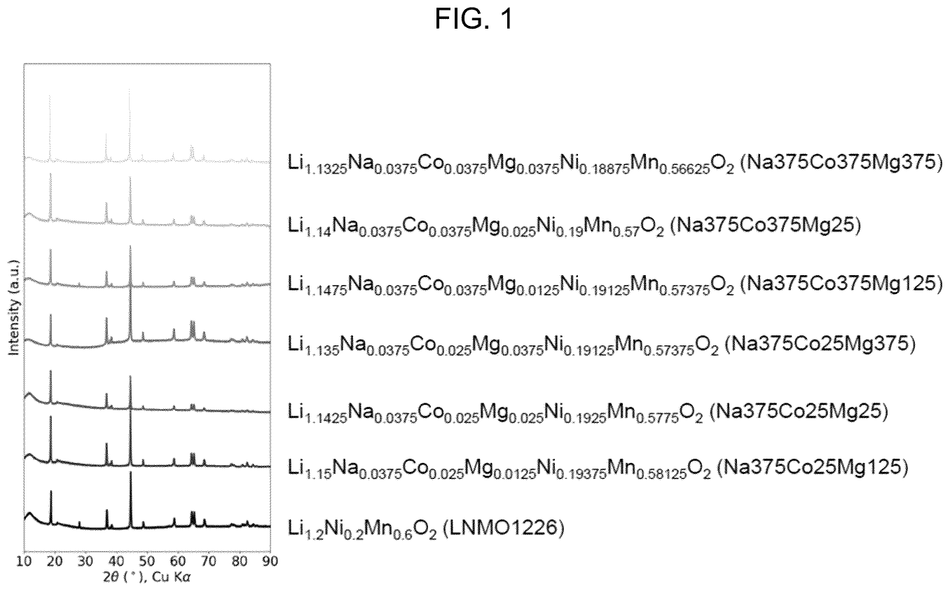

The specific embodiments of the present disclosure will now be described by way of FIGS. 1 to 3.

FIG. 1 is an X-ray diffraction pattern for synthesized Na/Co/Mg doped Li_{1.2}Ni_{0.2}Mn_{0.6}O₂(LNMO1226) embodiments of the present disclosure, namely, Li_{1.15}Na_{0.0375}Co_{0.025}Mg_{0.0125}Ni_{0.19375}Mn_{0.58125}O₂, Li_{1.1425}Na_{0.0375}Co_{0.025}Mg_{0.025}Ni_{0.1925}Mn_{0.5775}O₂, Li_{1.135}Na_{0.0375}Co_{0.025}Mg_{0.0375}Ni_{0.19125}Mn_{0.57375}O₂, Li_{1.1475}Na_{0.0375}Co_{0.0375}Mg_{0.0125}Ni_{0.19125}Mn_{0.57375}O₂, Li_{1.14}Na_{0.0375}Co_{0.0375}Mg_{0.025}Ni_{0.19}Mn_{0.57}O₂, and Li_{1.1325}Na_{0.0375}Co_{0.0375}Mg_{0.0375}Ni_{0.18875}Mn_{0.56625}O₂, as well as undoped Li_{1.2}Ni_{0.2}Mn_{0.6}O₂ for comparison.

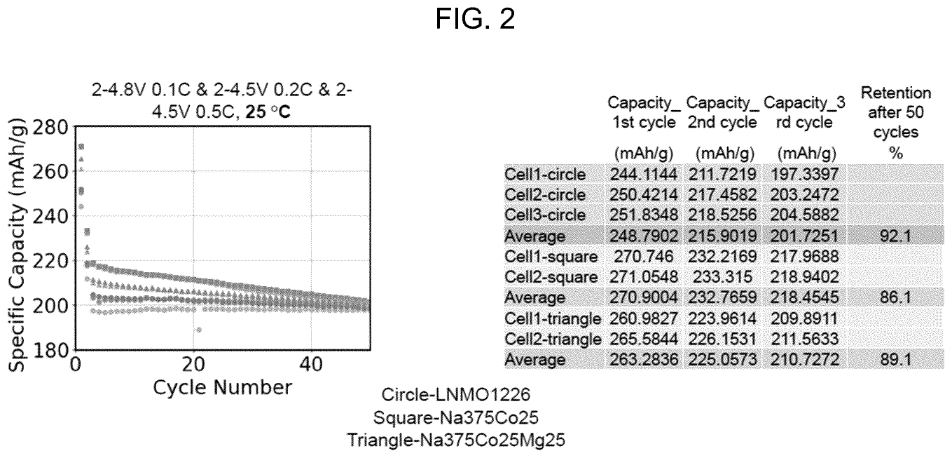

FIG. 2 shows a graph of specific capacity vs. cycle number (wherein the battery is only charged to a high voltage of 4.8V in the formation cycle and is charged within a narrow voltage window of 2 to 4.5V in subsequent cycles) and a corresponding table including an embodiment of the present disclosure, namely, Li_{1.1425}Na_{0.0375}Co_{0.025}Mg_{0.025}Ni_{0.1925}Mn_{0.5775}O₂ (Na375Co25Mg25), as well as comparison embodiments, namely, LNMO1226 and Na375Co25. FIG. 2 shows that Na⁺/Co³⁺/Mg²⁺ triple doping increases the capacity and retention, as can also be seen from the results shown in Table 1 below.

TABLE 1
Na⁺Co³⁺Mg²⁺ doping, 2-4.8 V 0.1 C & 2-4.5 V 0.2 C & 2-4.5 V 0.5 C, 25° C.

| | | | | Retention |
|---|---|---|---|---|
| | Capacity_1st | Capacity_2nd | Capacity_3rd | after 50 |
| | cycle | cycle | cycle | cycles |
| | (mAh/g) | (mAh/g) | (mAh/g) | % |
| LNMO1226 | | | | |
| Cell1 | 244.1144 | 211.7219 | 197.3397 | |
| Cell2 | 250.4214 | 217.4582 | 203.2472 | |
| Cell3 | 251.8348 | 218.5256 | 204.5882 | |
| Average | 248.7902 | 215.9019 | 201.7251 | 92.1 |
| Na375Co25 | | | | |
| Cell1 | 270.746 | 232.2169 | 217.9688 | |
| Cell2 | 271.0548 | 233.315 | 218.9402 | |
| Average | 270.9004 | 232.7659 | 218.4545 | 86.1 |
| Na375Co25Mg25 | | | | |
| Cell1 | 260.9827 | 223.9614 | 209.8911 | |
| Cell2 | 265.5844 | 226.1531 | 211.5633 | |
| Average | 263.2836 | 225.0573 | 210.7272 | 89.1 |

As can be seen from the results presented in Table 1, Na⁺/Co³⁺/Mg²⁺ triple doping increases the capacity and retention, with Na375Co25Mg25 having a higher capacity than LNMO1226 and having a higher retention than Na375Co25.

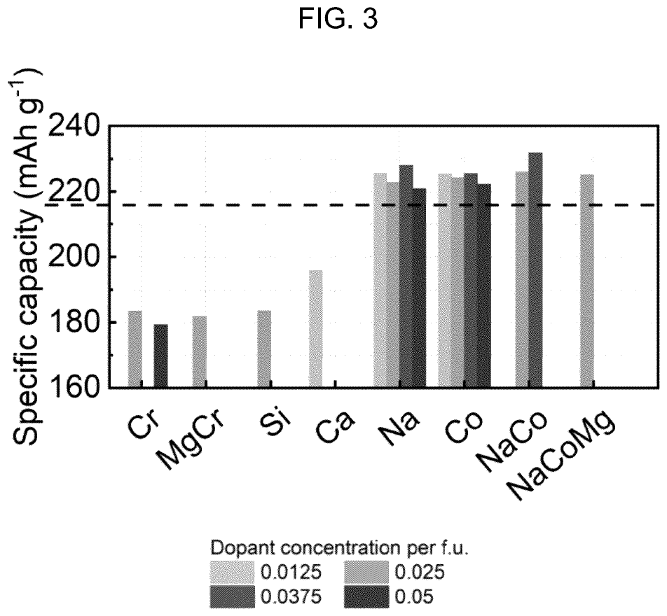

FIG. 3 is a graph showing the specific capacity for a Na/Co/Mg doped embodiment of the present disclosure compared with embodiments doped with other dopants (the dashed line is the specific capacity of undoped LNMO1226). As can be seen from FIG. 3, the NaCoMg triple doping of the present disclosure provides excellent results as compared with other doped embodiments, particularly embodiments based on either single doping with any of Cr, Si, and Ca or dual doping with MgCr.

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. Lithium nickel manganese-based oxide comprising sodium (Na), cobalt (Co), and magnesium (Mg) and represented by Formula 1, 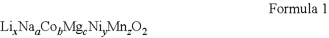
wherein, in Formula 1, 0.9≤x<1.2, 0<a≤0.0375, 0<b≤0.0375, 0<c≤0.0375, 0.1≤y<0.3, 0.3≤z<0.7.

2. The lithium nickel manganese-based oxide of claim 1, which is Li_{1.15}Na_{0.0375}Co_{0.025}Mg_{0.0125}Ni_{0.19375}Mn_{0.58125}O₂.

3. The lithium nickel manganese-based oxide of claim 1, which is Li_{1.1425}Na_{0.0375}Co_{0.025}Mg_{0.025}Ni_{0.1925}Mn_{0.5775}O₂.

4. The lithium nickel manganese-based oxide of claim 1, which is Li_{1.135}Na_{0.0375}Co_{0.025}Mg_{0.0375}Ni_{0.19125}Mn_{0.57375}O₂.

5. The lithium nickel manganese-based oxide of claim 1, which is Li_{1.1475}Na_{0.0375}Co_{0.0375}Mg_{0.0125}Ni_{0.19125}Mn_{0.57375}O₂.

6. The lithium nickel manganese-based oxide of claim 1, which is Li_{1.14}Na_{0.0375}Co_{0.0375}Mg_{0.025}Ni_{0.19}Mn_{0.57}O₂.

7. The lithium nickel manganese-based oxide of claim 1, which is Li_{1.1325}Na_{0.0375}Co_{0.0375}Mg_{0.0375}Ni_{0.18875}Mn_{0.56625}O₂.

8. A lithium, manganese-rich cathode comprising lithium nickel manganese-based oxide, wherein the lithium nickel manganese-based oxide comprises sodium (Na), cobalt (Co), and magnesium (Mg) and is represented by Formula 1, 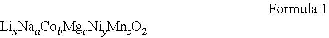
wherein, in Formula 1, 0.9≤x<1.2, 0<a≤0.0375, 0<b≤0.0375, 0<c≤0.0375, 0.1≤y<0.3, 0.3≤z<0.7.

9. A lithium-ion battery comprising an anode, a cathode, and an electrolyte, wherein the cathode is a lithium, manganese-rich cathode comprising lithium nickel manganese-based oxide, wherein the lithium nickel manganese-based oxide comprises sodium (Na), cobalt (Co), and magnesium (Mg) and is represented by Formula 1, 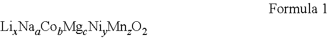
wherein, in Formula 1, 0.9≤x<1.2, 0<a≤0.0375, 0<b≤0.0375, 0<c≤0.0375, 0.1≤y<0.3, 0.3≤z<0.7.
